(19) United States
(12) Patent Application Publication
(10) Pub. No.: US 2023/0089377 A1
(43) Pub. Date: Mar. 23, 2023

(54) CONTACT SLEEVE, CAMERA OBJECTIVE WITH CONTACT SLEEVE, USE OF A CONTACT SLEEVE

(71) Applicant: Robert Bosch GmbH, Stuttgart (DE)

(72) Inventors: Moritz Winkler, Waldbronn (DE); Andreas Moehrle, Stuttgart (DE); Nikolai Bauer, Moeglingen (DE)

(21) Appl. No.: 17/896,980

(22) Filed: Aug. 26, 2022

(30) Foreign Application Priority Data
Sep. 22, 2021 (DE) 10 2021 210 511.4

(51) Int. Cl. G02B 27/00; G03B 17/55

(52) U.S. Cl. CPC G02B 27/0006; G03B 17/55

(57) ABSTRACT

A contact sleeve for a camera objective. The contact sleeve includes a sleeve-shaped base body made of an electrically non-conductive material, as well as at least one electrical conductor embedded in the material of the base body, preferably a contact pin, which has, at at least one end, an exposed contacting portion for electrically contacting an electrical consumer integrated in the camera objective. A camera objective having a contact sleeve and the use of the contact sleeve for contacting an electrical consumer of a camera objective, are also described.

### CROSS REFERENCE

The present application claims the benefit under 35 U.S.C. § 119 of German Patent Application No. DE 10 2021 210 511.4 filed on Sep. 22, 2021, which is expressly incorporated herein by reference in its entirety.

### FIELD

The present invention relates to a contact sleeve for a camera objective and to a camera objective with a corresponding contact sleeve. Furthermore, the present invention relates to the use of a contact sleeve according to the present invention for electrically contacting an electrical consumer integrated in a camera objective. The electrical consumer may, for example, be a heating device that can be used to heat a component of the camera objective, in particular an optical lens, at risk of icing.

The present invention can in particular be used in automotive camera systems, for example for environmental monitoring. Further areas of application include camera systems from the consumer sector and/or for professional applications.

### BACKGROUND INFORMATION

An electrical consumer, such as a heating device, integrated in a camera objective must be supplied with electrical power. For this purpose, the electrical consumer is usually connected by means of conductor tracks to the electronics of the camera, in particular to a printed circuit board that accommodates an image sensor.

European Patent No. EP 3 094 078 A1 describes, by way of example, a camera module with an objective, in which an electrical consumer in the form of an actuator is integrated. The electrical contacting is realized via conductor tracks, which extend from the electrical consumer along an objective holder to the printed circuit board for this purpose.

As an alternative to conductor tracks, the electrical connection or contacting can also be produced by means of contact pins. However, the latter have the disadvantage that they are not flexible and can thus impede the necessary alignment of the camera objective in relation to the image sensor. Furthermore, the contact pins must be electrically insulated from metallic housing parts, which may in particular prove to be problematic when the objective housing is made of metal.

### SUMMARY

An object of the present invention is to make the contacting and power supply of an electrical consumer integrated in a camera objective easier and at the same time safer.

In order to achieve this object, the contact sleeve of the present invention as well as the camera objective with the features of the present invention, are provided. Advantageous developments of the present invention are disclosed herein. In addition, a preferred use of a contact sleeve according to the present invention is disclosed herein.

According to an example embodiment of the present invention, the contact sleeve provided for a camera objective comprises a sleeve-shaped base body made of an electrically non-conductive material, as well as at least one electrical conductor embedded in the material of the base body, preferably a contact pin, which has, at at least one end, an exposed contacting portion for electrically contacting an electrical consumer integrated in the camera objective.

By means of the at least one electrical conductor integrated in the base body of the contact sleeve, the electrical consumer can be contacted and supplied with power. Preferably, at least two electrical conductors for realizing a positive and a negative pole are provided. Since the at least one electrical conductor is embedded in the electrically non-conductive material of the base body, it is at the same time electrically insulated so that the contact sleeve can also be connected to a camera objective comprising a metallic objective housing. The electrical conductor comprises an exposed contacting portion only at one end or at both ends in order to produce the necessary electrical contacting.

The electrical contacting of the electrical consumer can already be realized in a simple manner when the contact sleeve is attached to, in particular pushed onto, the camera objective. This applies in particular if the at least one electrical conductor is embodied as a contact pin, which projects beyond the contact sleeve in the axial direction so that it makes contact with the electrical consumer when the contact sleeve is pushed onto the camera objective. The stiffness of the contact pins ensures safe and permanent contacting. Advantageously, when the contact sleeve is pushed onto the camera objective, the contact pin is inserted into a receptacle of the electrical consumer so that a defined contact point is created therethrough.

The power supply is likewise realized by means of the at least one electrical conductor, which extends through the contact sleeve in the axial direction for this purpose, preferably from a first end face to an opposite second end face of the contact sleeve. In this way, an axial distance of the electrical consumer from the electronics of the camera can be bridged by means of the electrical conductor.

As already mentioned, according to an example embodiment of the present invention, at least two electrical conductors, in particular contact pins, are preferably provided. These electrical conductors preferably extend in parallel, furthermore preferably in the axial direction. Alternatively or additionally, it is suggested that the two electrical conductors, in particular contact pins, are diametrically opposite one another on the base body. This applies in particular if the one electrical conductor forms a positive pole and the other electrical conductor forms a negative pole.

According to an example embodiment of the present invention, a first exposed contacting portion of the at least one electrical conductor is preferably formed by an end portion of the electrical conductor protruding beyond the contact sleeve. That is to say, the at least one electrical conductor projects beyond the contact sleeve in the axial direction. In this case, the protruding contacting portion can easily be brought into contact with the electrical consumer when the contact sleeve is pushed onto the camera objective.

According to an example embodiment of the present invention, a second exposed contacting portion is preferably formed by an exposed circumferential region of the electrical conductor, which is preferably arranged in the region of a material recess of the base body. In this case, the material recess is likewise formed in a circumferential region of the base body, preferably in an outer circumferential region. Because then, after pushing the contact sleeve onto the camera objective and subsequently inserting the camera objective into an objective holder, the contacting portion can be easily brought into contact with a contact element integrated in the objective holder. This does not impede the alignment of the camera objective in relation to an image sensor.

According to a preferred example embodiment of the present invention, the base body is embodied as a hollow cylinder with an annular collar. The contact sleeve can be supported in the axial direction on the camera objective via the annular collar. The annular collar preferably extends radially outward so that the inner diameter of the hollow cylinder can be adapted to the outer diameter of the camera objective in order to keep the installation space requirement of the contact sleeve as minimal as possible.

In order to fix the position of the contact sleeve on the camera objective, it is proposed in a development of the invention that the base body has, in the region of an end face and/or of an inner circumferential surface, at least one geometry, in particular a latching geometry, which can be brought into engagement with a geometry and/or recess of the camera objective. By means of a geometry arranged in the region of an end face, an anti-rotation lock can in particular be realized.

By means of a geometry formed in the region of an inner circumferential surface, a positional lock in the axial direction can in particular be brought about. The geometry arranged on the inner circumferential side can be embodied as a detent or circumferential bead, for example. The camera objective may then have a recess that is adapted to the detent or to the bead and in which the detent or the bead engages.

The contact sleeve provided according to an example embodiment of the present invention may be connected to a camera objective in a simple manner so that the contact sleeve may be pre-assembled and the camera objective may be inserted with the contact sleeve as a pre-assembled unit into an objective holder. With the assembly, the electrical contacting takes place at the same time.

The contact sleeve according to an example embodiment of the present invention may also be connected to a plurality of different camera objectives, regardless of what material the objective housing of the camera objective is made of. For example, the objective housing may be made of metal. Since the base body of the contact sleeve is made of an electrically non-conductive material, electrical insulation of the at least one electrical conductor from the objective housing is achieved via the base body. By means of the contact sleeve according to the invention, a modular approach can thus be realized that provides a contacting and power supply concept for a variety of camera objectives.

Advantageously, the contact sleeve is an injection-molded part, in particular a plastic injection-molded part. Because as such, the contact sleeve is simple and inexpensive to produce. The at least one electrical conductor may also be placed into the injection mold and overmolded so that it is embedded in the material of the base body.

In addition, a camera objective with a contact sleeve according to the present invention is provided. The contact sleeve is in this case arranged on a shaft of the camera objective. Furthermore preferably, the contact sleeve is positionally fixed to the shaft.

For fixing or securing the position of the contact sleeve on the shaft, at least one geometry formed in the region of an end face and/or of an inner circumferential surface of the base body of the contact sleeve preferably engages with a geometry and/or recess of the camera objective. In this way, a positive connection between the contact sleeve and the camera objective is achieved for anti-rotation locking and/or axial positional locking. The geometry may in particular be a latching geometry that can be brought into a latching engagement with a geometry and/or recess of the camera objective. The latching connection facilitates assembly of the contact sleeve on the camera objective. The latching geometry may, for example, be a detent or circumferential bead that engages in a corresponding recess of the camera objective.

Alternatively or additionally, it is provided that the contact sleeve is supported in the axial direction, preferably via an annular collar of the base body, on a radially extending shoulder of the shaft of the camera objective. In this case, the contact sleeve is already positionally secured in an axial direction via the shoulder of the shaft.

Furthermore, according to an example embodiment of the present invention, the use of a contact sleeve according to the invention is provided for electrically contacting an electrical consumer integrated in a camera objective. The contact sleeve facilitates the necessary electrical contacting of the electrical consumer, which can in particular be a heating device for heating a front lens of the camera objective. Because by means of the contact sleeve, the axial distance between the heating device mounted in the region of the front lens and the electronics of the camera can be bridged in a simple manner.

The features of the contact sleeve that is based on a modular approach can also be applied to a variety of different camera objectives.

Preferred example embodiments of the present invention are described in more detail below with reference to the figures.

### BRIEF DESCRIPTION OF THE DRAWINGS

FIG. 1 shows a sectional view through a contact sleeve according to the invention in accordance with a first preferred example embodiment of the present invention.

FIG. 2 shows a perspective view of the contact sleeve of FIG. 1.

FIG. 3 shows a longitudinal section through a contact sleeve according to the present invention in accordance with a further preferred example embodiment.

FIG. 4 shows a side view of the contact sleeve of FIG. 3.

FIG. 5 shows a longitudinal section through a camera objective according to the present invention with a contact sleeve analogous to FIGS. 3 and 4.

FIG. 6 shows a sectional view through the camera objective of FIG. 5.

FIG. 7 shows a perspective view of the camera objective of FIGS. 5 and 6.

FIG. 8 shows an enlarged detail of the longitudinal section of FIG. 5.

### DETAILED DESCRIPTION OF EXAMPLE EMBODIMENTS

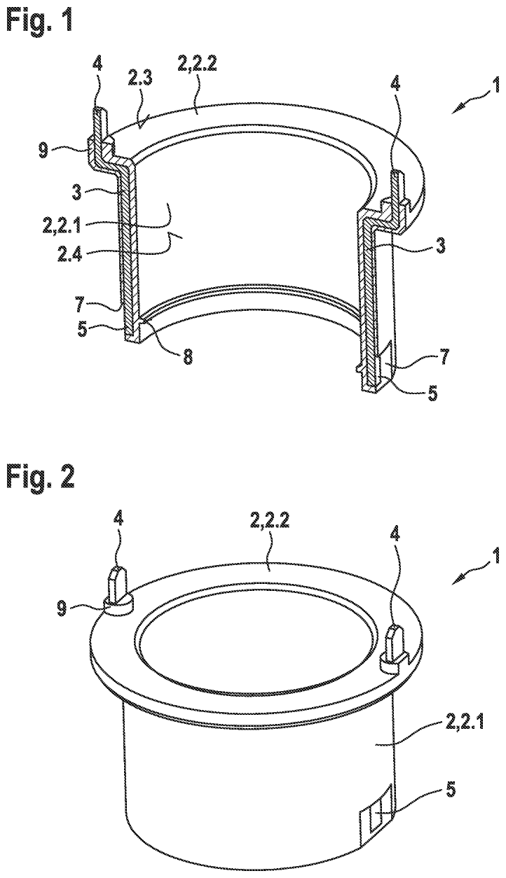

FIG. 1 shows a contact sleeve 1 according to the present invention for a camera objective 10 for contacting an electrical consumer 6 integrated in the camera objective 10 (analogously to FIG. 6). The contact sleeve 1 shown in FIG. 1 comprises a base body 2 made of an electrically non-conductive material, in particular plastic, in which two electrical conductors 3 are each embedded in the form of a contact pin. The two contact pins extend substantially in parallel to one another as well as in parallel to a longitudinal axis of the contact sleeve 1, wherein at one end, the contact pins project beyond an annular collar 2.2 of the base body 2 so that first contacting portions 4 are formed. At the other end, in the region of material recesses 7 of a hollow cylinder 2.1 of the base body 2, contacting portions 5 are exposed (see also FIG. 2).

The contact pins are diametrically opposite one another on the base body 2 of the contact sleeve 1, wherein a first contact pin forms a positive pole and a second contact pin forms a negative pole. A geometry 8 in the form of a circumferential bead formed in the region of an inner circumferential surface 2.4 of the hollow cylinder 2.1 can be brought into engagement with a recess 11 of the camera objective 10 in order to secure the position of the contact sleeve 1 in the axial direction (analogously to FIG. 8). In the region of an end face 2.3 of the base body 2, further geometries 9 are formed, which rise above the annular collar 2.2 and surround the contact pins. The geometries 9 can likewise be brought into engagement with the camera objective 10 so that an anti-rotation lock can be realized therethrough.

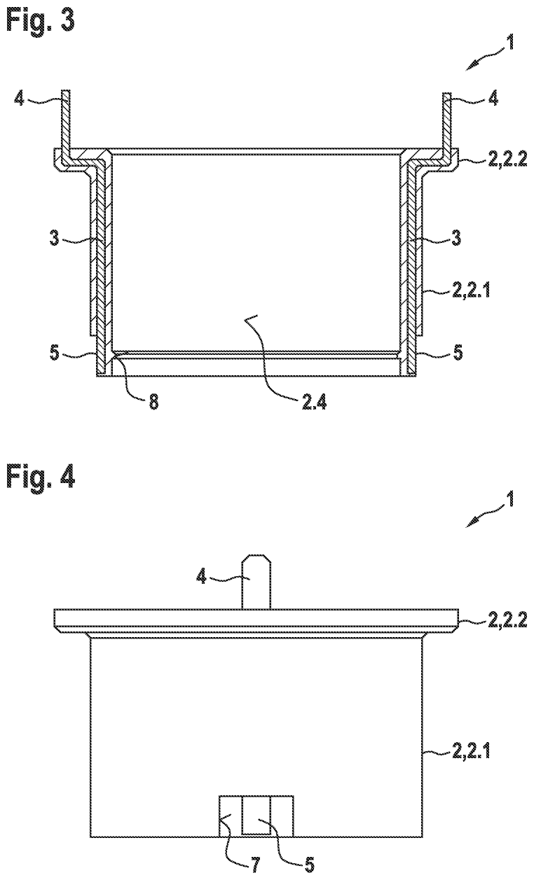

As shown by way of example in FIGS. 3 and 4, the geometries 9 can also be omitted. This is in particular the case if the contact pins form plug contacts that can be plugged into corresponding receptacles of the electrical consumer 6 so that a certain anti-rotation lock is already achieved therethrough.

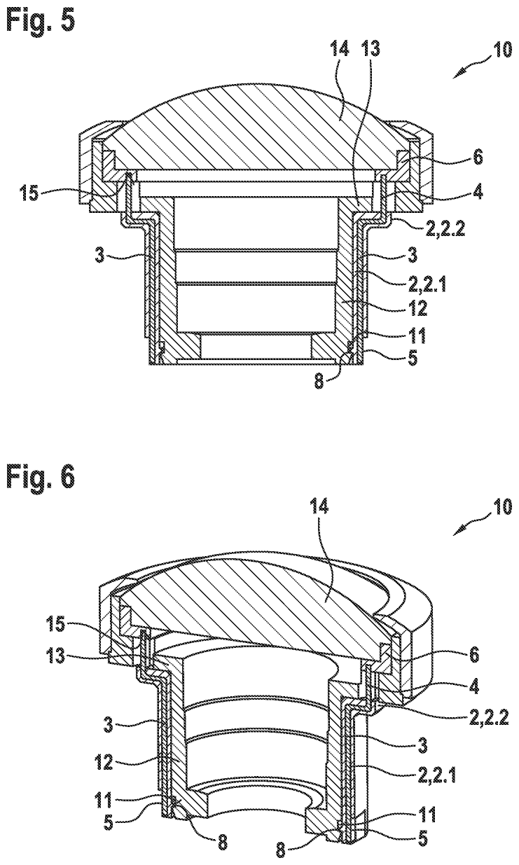

FIGS. 5 to 7 show the contact sleeve 1 of FIGS. 3 and 4 plugged onto a shaft 12 of a camera objective 10, in which a heating device as an electrical consumer 6 is integrated. By means of the heating device, a lens 14 of the camera objective 10 can be heated to keep it free of precipitation and ice. For this purpose, the heating device is formed as a ring that directly abuts the lens 14.

For the power supply, the heating device is connected to an electronics (not shown) which is located on the side of the camera objective 10 facing away from the lens 14. That is to say, an axial distance between the heating device and the electronics must be bridged. The contact sleeve 1 assumes this task, including the electrical contacting. For this purpose, the contact sleeve 1 is pushed onto the shaft 12 of the camera objective 10 until the circumferential bead snaps into the recess 11 of the shaft 12 and the annular collar 2.2 of the base body 2 abuts against a radially extending shoulder 13 of the camera objective 10. In the process, the contacting portions 4 of the contact pins engage in recesses 15 of the heating device so that an anti-rotation lock is given therethrough. During the pushing-on process, attention must therefore be paid to the angular position of the contact sleeve 1 in relation to the camera objective 10.

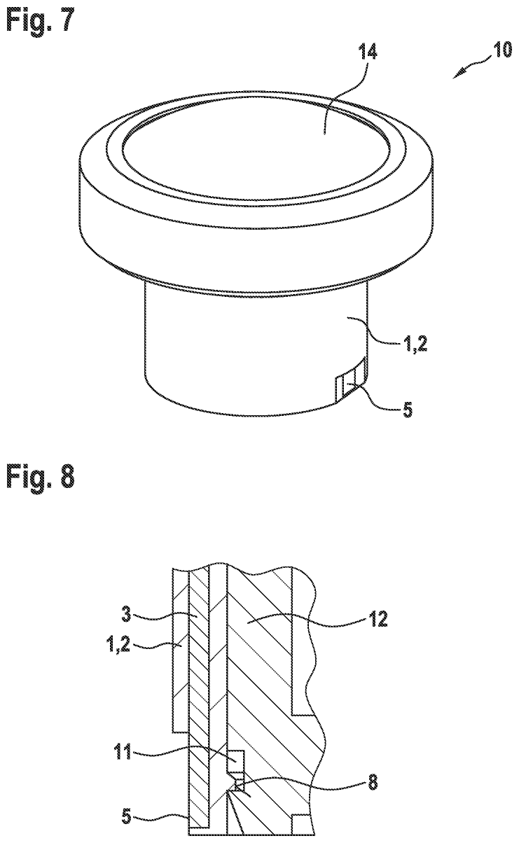

The contact sleeve 1, attached to the shaft 12, and the camera objective 10 form a pre-assembled unit (see FIG. 7), which preferably only needs to be inserted into an objective holder (not shown) comprising suitable contact elements for contacting the contacting portions 5 of the contact pins of the contact sleeve 1. The fixing of the position of the contact sleeve 1 on the camera objective 10 facilitates insertion. In addition, the camera objective 10 may be aligned in the familiar manner in relation to an image sensor (not shown) connected to the objective holder.

What is claimed is:

1. A contact sleeve for a camera objective, comprising:
a sleeve-shaped base body made of an electrically non-conductive material;
at least one electrical conductor embedded in the material of the base body, which has, at at least one end, an exposed contacting portion configured to electrically contact an electrical consumer integrated in the camera objective.

2. The contact sleeve as recited in claim 1, wherein the electrical conductor is a contact pin.

3. The contact sleeve as recited in claim 1, wherein at least two electrical conductors are provided, which furthermore extend in parallel to one another and/or are diametrically opposite to one another on the base body.

4. The contact sleeve as recited in claim 3, wherein the electrical conductors are contact pins.

5. The contact sleeve as recited in claim 1, wherein a first exposed contacting portion is formed by an end portion of the electrical conductor protruding beyond the contact sleeve.

6. The contact sleeve as recited in claim 1, wherein a second exposed contacting portion is formed by an exposed circumferential region of the electrical conductor and is arranged in a region of a material recess of the base body.

7. The contact sleeve as recited in claim 1, wherein the base body is a hollow cylinder with an annular collar, wherein the annular collar extending radially outward.

8. The contact sleeve as recited in claim 1, wherein the base body has, in a region of an end face and/or of an inner circumferential surface, at least one latching geometry, which can be brought into engagement with a geometry and/or recess of the camera objective to secure a position of the contact sleeve on the camera objective.

9. A camera objective, comprising:
a contact sleeve including:
a sleeve-shaped base body made of an electrically non-conductive material, and
at least one electrical conductor embedded in the material of the base body, which has, at at least one end, an exposed contacting portion electrically contacting an electrical consumer integrated in the camera objective;
wherein the contact sleeve is arranged on a shaft of the camera objective.

10. The camera objective as recited in claim 9, wherein, to secure a position of the contact sleeve on the shaft, at least one geometry formed in a region of an end face and/or of an inner circumferential surface of the base body, the geometry being a latching geometry, in engagement with a geometry and/or recess of the camera objective.

11. The camera objective as recited in claim 9, wherein the contact sleeve is supported in an axial direction, via an annular collar of the base body, on a radially extending shoulder of the shaft.

12. A method comprising:
providing a camera objective, including:
a contact sleeve including:
a sleeve-shaped base body made of an electrically non-conductive material, and
at least one electrical conductor embedded in the material of the base body, which has, at at least one end, an exposed contacting portion electrically contacting an electrical consumer integrated in the camera objective;
wherein the contact sleeve is arranged on a shaft of the camera objective; and
using the camera objective.
